(19) United States
(12) Patent Application Publication
(10) Pub. No.: US 2024/0308599 A1
(43) Pub. Date: Sep. 19, 2024

(54) INTERMODAL CHASSIS AND TRAILER

(71) Applicant: Trevor Pan, Tempe, AZ (US)

(72) Inventor: Trevor Pan, Tempe, AZ (US)

(21) Appl. No.: 18/402,723

(22) Filed: Jan. 2, 2024

Related U.S. Application Data
(60) Provisional application No. 63/436,685, filed on Jan. 2, 2023.

(51) Int. Cl. B62D 33/077; B60P 1/64; B62D 33/04; B62D 35/00

(52) U.S. Cl. CPC B62D 33/077; B60P 1/6418; B62D 33/04; B62D 35/001

(57) ABSTRACT

In the field of intermodal logistics, a modified intermodal chassis having a floor and side walls, and roof panels. Both the side walls and roof panels open and close enabling the intermodal chassis and trailer to move series 1 freight containers and general cargo.

### CROSS-REFERENCE TO RELATED APPLICATIONS

Provisional application of Ser. No. U.S. 63/436,685, filed Jan. 2, 2023.

### STATEMENT REGARDING FEDERALLY SPONSORED RESEARCH OR DEVELOPMENT

None.

### BACKGROUND

### Field of the Invention

The present invention is directed to an aerodynamic tractor trailer that may also double as an intermodal chassis with the aim of hauling either a series 1 freight container, or general cargo when empty, therein providing a more versatile trailer, for the truck driving professional. In addition, a frame enables aerodynamic fairings to be applied or removed. This ensures future progress in aerodynamic shapes may be applied to the trailer walls.

### Description of the Related Art

Truck driving professionals make money when driving. They go to great lengths with apps, bid boards, website requests, and professional connections to keep their trucks running with loads.

If a logistics company has dry vans and a customer orders a shipping container they may not have an intermodal chassis to receive the container. They might lose that extra job in this case.

Ports often have chassis pools that rent intermodal chassis. Sometimes they are all in use.

Conversely, some logistics companies work the ports but may not have dry vans. Once they deliver a shipping container to a warehouse they could continue to serve the customer after the contents have been removed. However, if they don't own dry vans they might lose this delivery.

### BRIEF SUMMARY

I have recognized that logistics aerodynamic apparatus are piecemeal. If designing a new trailer with changeable fairings were made possible a trailer would change with the times.

Further, if walls of a dry van trailer could spread apart with pivot points or sliding apparatus then a truck driver could be more versatile in their work. They could pick up shipping containers one day and deliver “less than truckloads” tomorrow.

### BRIEF DESCRIPTION OF THE DRAWINGS

FIG. 1 A side perspective front view of a prior art semi-truck and an intermodal chassis and trailer to house general cargo and a series 1 freight container.

FIG. 2 A perspective side rear view of a prior art semi-truck and an intermodal chassis and trailer to house general cargo and a series 1 freight container.

FIG. 3 A plan view of a prior art semi-truck and an intermodal chassis and trailer to house general cargo and a series 1 freight container.

FIG. 4 A front perspective view of a prior art semi-truck and exposed frame of an intermodal chassis and trailer.

FIG. 5 A section view of an intermodal chassis and trailer depicting how the walls will tilt and cover a series 1 freight container.

FIG. 6 An side elevation view of a prior art semi-truck and the frame of an intermodal chassis and trailer shows how aerodynamic profiles can clip in to the frame.

### DETAILED DESCRIPTION

In one embodiment of the present invention a pair of motorized tilt walls are bolted to a chassis having pivot points. The motors are powered by the semi-truck 12v battery. The structure for the tilt walls enables the wall to tilt away from the sides of a series 1 freight container so that a spreader may lift or lower a container on or off the chassis. After a container has been removed the tilt walls may be closed.

Once closed the trailer operates as a dry-van. In this state the trailer is free to carry general cargo. In essence it is a semi-truck trailer. This allows the logistics operator the freedom to move multiple modes of freight with one trailer.

In another embodiment a frame having standardized connections enables the truck owner to change out aerodynamic profiles on the trailer. These aerodynamic profiles can improve with time, as engineers have new discoveries.

This embodiment does not render a trailer obsolete.

### BEST MODE FOR CARRYING OUT THE INVENTION

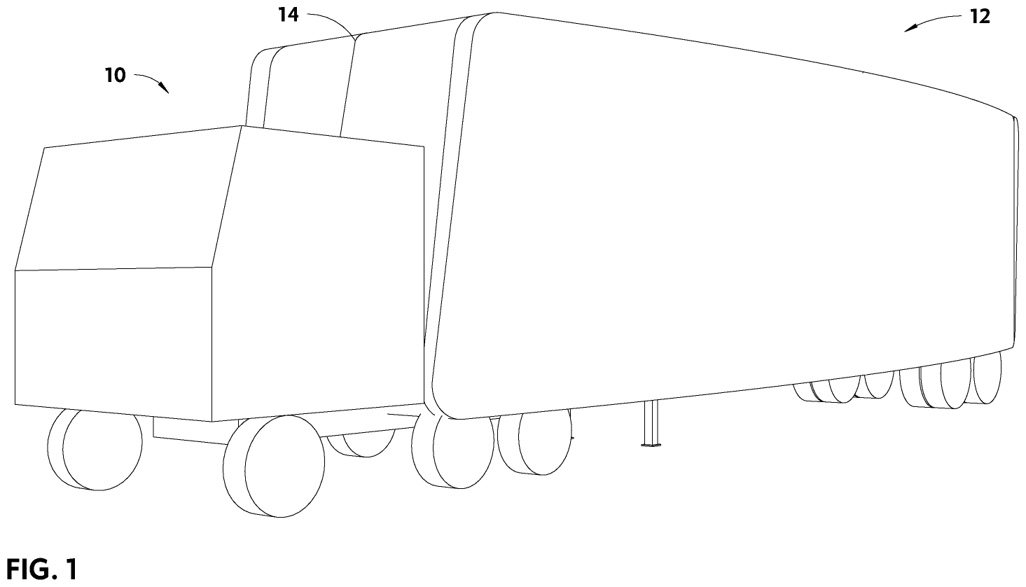

FIG. 1 A side front perspective view of a prior art semi-truck 10 and an intermodal chassis and trailer 12 to house general cargo and series 1 freight containers.

A seam 14 is shown where the two halves of the trailer could meet. The intermodal chassis and trailer 12 has sculpted aerodynamics and the intent is that no add-on exterior 100 fairings will be required to achieve its maximum fuel efficiency.

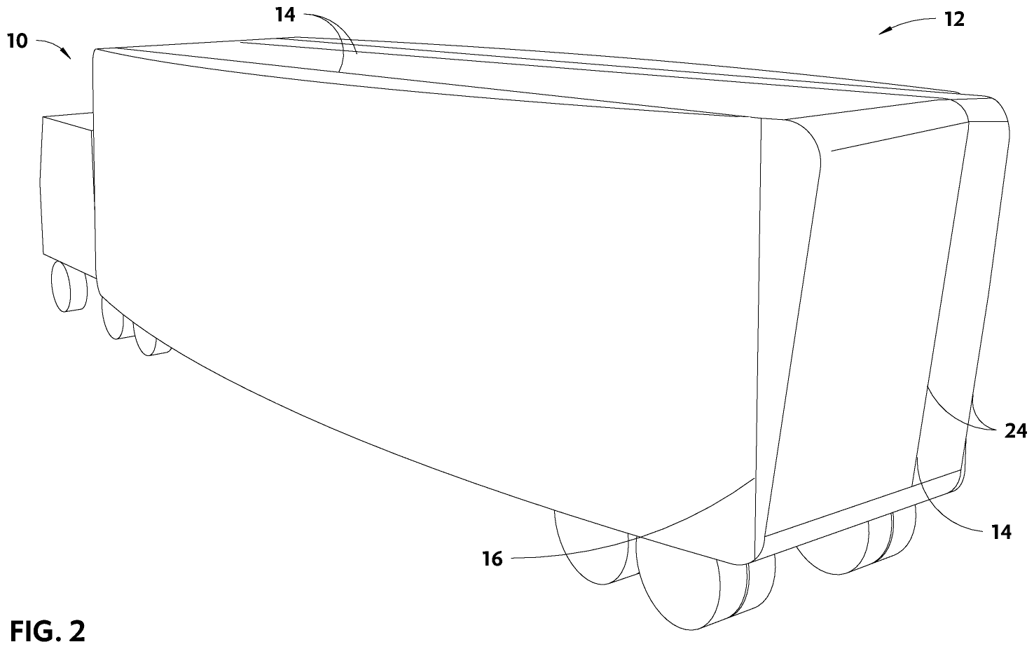

FIG. 2 A side rear view of a prior art semi-truck 10 and an intermodal chassis and trailer 12 to house general cargo and series 1 freight containers.

A seam 14 is shown splitting the trailer down the middle. This allows for both side walls to pull away from the center and expose a series 1 freight container.

Hinges 16 enable the rear doors to swing open for dock access.

A seam 14 is shown splitting the trailer down the middle. This allows for both side walls to pull away from the center and exposing a series 1 freight container. Other locations for seams can be on a per customer basis.

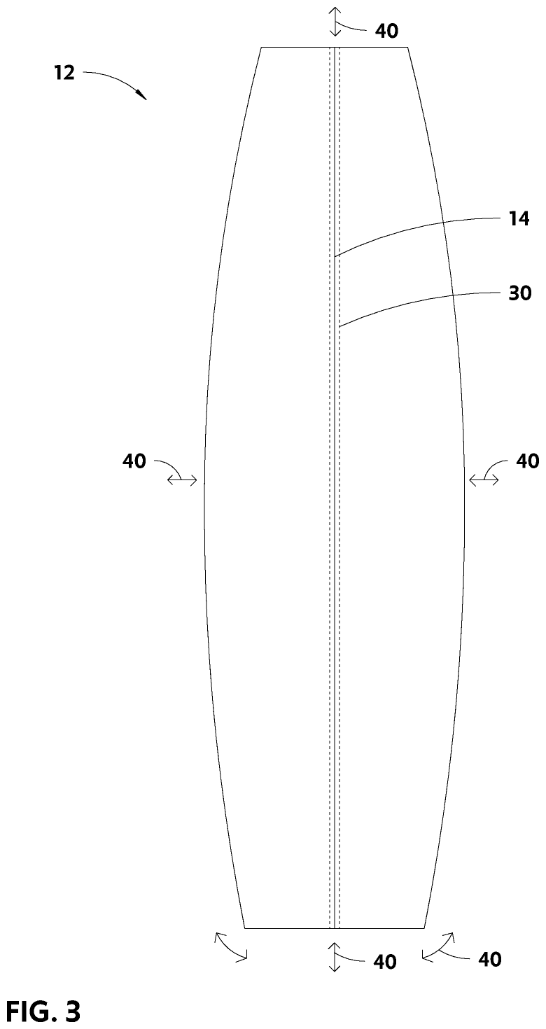

FIG. 3 Is a plan view of the intermodal chassis and trailer. A waterproof trough 30 with 115 overlapping weather seal 31 keeps the roof panels water tight. With the seam 14 tightly closed and the trailer empty of series 1 freight containers the trailer may move general freight just like a dry-van. Tilt wall doors 24 open up to work at warehouse docks.

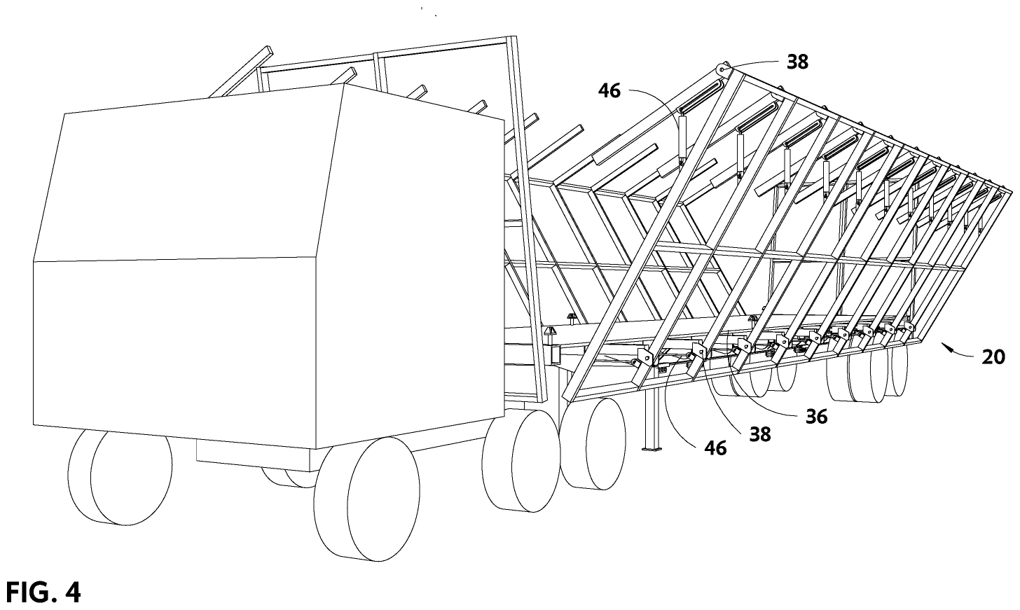

FIG. 4 Is a front perspective view of the frame of an intermodal chassis and trailer 12. Hydraulic pistons 46 are one means to further pivot the roof panels 43 and side walls 18. Rack and pinion could also work for some movements.

Pivot points 38 enable the hydraulic pistons to cause rotational movement.

A floor 36 differs from a traditional, prior art intermodal chassis which are open. The floor 36 allows for general cargo conveyance.

Series 1 freight containers may be lowered onto a flat interior floor 36, where twist locks 26 lock the container down.

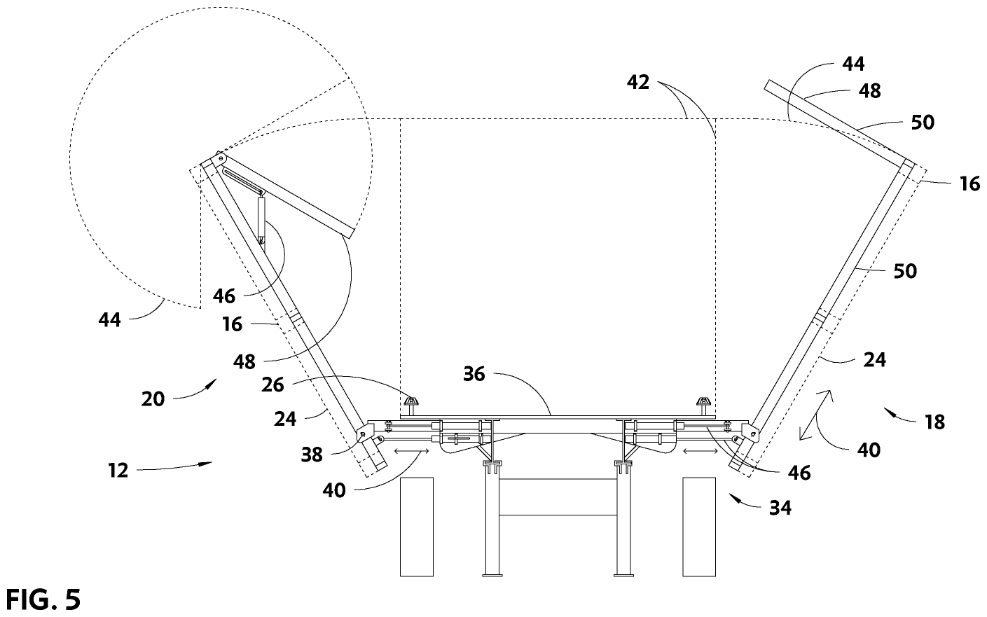

FIG. 5 A section view of an intermodal chassis and trailer depict how the walls will tilt and cover a series 1 freight container outline of series 1 freight container 42.

A motor 28 with structural struts and rollers, or hydraulic pistons 46, extends and retracts 135 each side wall 18, 20.

Each wall may retract sideways and vertically with hydraulic pistons or similar movement means. This allows container spreader 22 to lift or lower a series 1 freight container onto the trailer floor 36.

Like an intermodal chassis the trailer 12 has twist locks 26 at the corners of the chassis to enable a structural connection. However, unlike an intermodal chassis where series 1 freight container flutes cause turbulence this trailer completely covers the container and provides superior aerodynamics.

At the seam 14 a waterproof trough 30 and positive flashing 32 provide a waterproof joint along with seals as required.

The tilt wall 18 differs from hinged tilt wall 20 in that it is fixed and moves as a unit. Hinged tilt wall 20 bends to enable a container spreader 22 better access. It is not a requirement to have different tilt walls.

A sliding vertical tilt wall 34 shows a possible embodiment to reduce the height of the tilt wall for convenience of the container spreader 22 operator. See movement arrows 40.

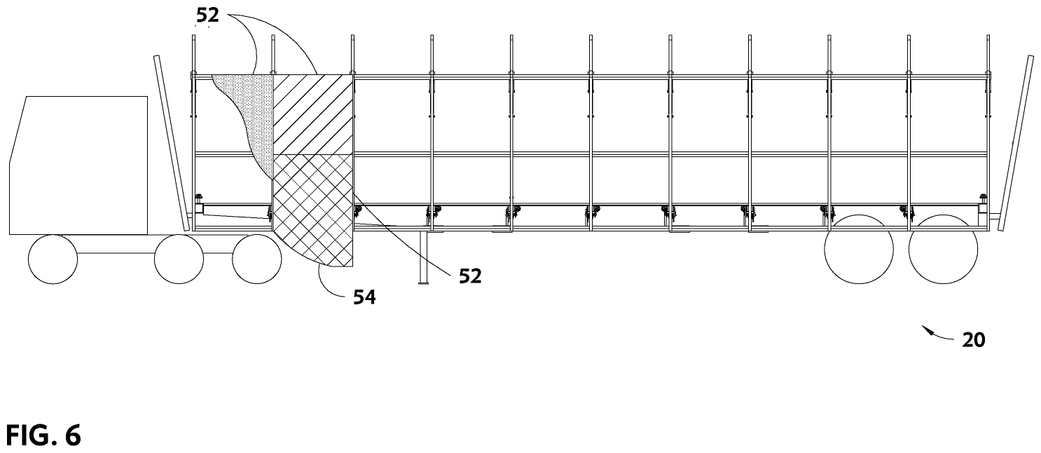

FIG. 6 Is an elevation view of an intermodal chassis and trailer.

Aerodynamic profiles 54 are panels that clip to the frame 50. In this manner, the intermodal chassis and trailer can stay modern in its profile. This will take advantage of any future aerodynamic improvements. The various patterns on the aerodynamics profiles 52 show how different shapes could be applied for better aerodynamic performance.

Waterproofing, and flashing will be added to the joints as required.

In this manner, this trailer is more effective than a prior art trailer and an intermodal chassis.

Why own two trailers when one will do the job?

Imagine the emissions savings, yard space opened up and reduction of intermodal chassis stacker equipment.

### REFERENCE SIGNS LIST—(NUMBERS ARE BOLDED IN DESCRIPTION)

10 prior art semi truck
12 intermodal chassis and trailer
14 seam
16 hinges
18 side wall
20 hinged tilt wall
22 container spreader
24 tilt wall doors
26 twist locks
28 motor
30 waterproof trough
31 overlapping weather seal
32 positive flashing
34 sliding vertical tilt wall
36 floor
38 pivot point
40 movement arrows
42 outline of a series 1 freight container
44 radius movement
46 hydraulic piston; rack and pinion where applicable
48 roof panel
50 frame
52 skirt equivalent
54 aerodynamic profile

### CITATION LIST

The following is a tabulation of some prior art that presently appears relevant.

### U.S. Patents

| Patent Number | Kind Code | Issue Date | Patentee |
|---|---|---|---|
| U.S. Pat. No. 10,745,066 | B2 | 2020 Aug. 18 | Prakash et al. |
| U.S. Pat. No. 4,756,256 | | 1988 Jul. 12 | Rains et al. |
| U.S. Pat. No. 4,518,188 | | 1985 May 21 | Witten |
| U.S. Pat. No. 8,496,286 | B1 | 2013 Jul. 30 | Katz et al. |
| U.S. Pat. No. 3,372,503 | | 1968 Mar. 12 | Weeks |

### U.S. Patent Application Publications

| Patent Number | Kind Code | Issue Date | Patentee |
|---|---|---|---|
| US 20090230725 | A1 | 2009 Sep. 17 | Juieng |
| US 2010/0116932 | A1 | 2010 May 13 | Helou, Jr. |
| US 2011/0181072 | A1 | 2011 Jul. 28 | Kempster |

### Foreign Patent Documents

| Foreign Doc. Num. | Kind Code | Issue Date | App or Patentee |
|---|---|---|---|
| WO 2021/124175 | A1 | 2021 Jun. 24 | 3M Innovative Properties |
| | | | Company |

### Nonpatent Literature Documents

Levinson, Marc, The Box: How the Shipping Container Made the World Smaller and the World Economy Bigger, (Princeton, NJ), pp. 68, 191.
Sidewall (40′ High Cube) CX44-Bundle|InSoFast Container Insulation. (n.d.). InSoFast. https://www.insofast.com/products/40-ft-shipping-container-insulation-9-ft-high-cube-sidewall-cx44-bundle.html
Brandon Hilliard Follow. (n.d.). An aerodynamic study of bulk commodity tractor trailers. Share and Discover Knowledge on SlideShare. https://www.slideshare.net/BrandonHilliard6/an-aerodynamic-study-of-bulk-commodity-tractor-trailers
Roeth, M. (2015 Jul. 17). Miles to Go|Running Green content from Fleet Owner. web.archive.org. https://web.archive.org/web/20150726054227/http://fleetowner.com/running-green/miles-go
National Average Gas Prices. AAA Gas Prices. (n.d.). Retrieved Jul. 28, 2022, from https://gasprices.aaa.com/

I claim:

1) In the field of intermodal logistics an intermodal chassis and trailer comprising:
an intermodal chassis having a floor;
a plurality of side walls;
a plurality of pivot points that connect to both said intermodal chassis, and said plurality of side walls;
said pivot points enable said plurality of side walls to open, providing space for a machine to both lower a series 1 freight container onto said intermodal chassis, and lift said series 1 freight container off of said intermodal chassis;
in this manner, an intermodal chassis and trailer are formed.

2) In the field of intermodal logistics an intermodal chassis and trailer comprising:
an intermodal chassis having a floor;
a plurality of side walls;
a means for both extending, and retracting, said plurality of side walls that connect to both said intermodal chassis, and said plurality of side walls;
said means for both extending, and retracting enable said plurality of side walls to open, providing space for a machine to both lower a series 1 freight container onto said intermodal chassis, and lift said series 1 freight container off of said intermodal chassis;
in this manner, an intermodal chassis and trailer are formed.

3) In the field of intermodal logistics an intermodal chassis and trailer comprising:
an intermodal chassis having a floor;
a plurality of side walls;
said plurality of side walls further each have a plurality of roof panels connected to said plurality of side walls;
a plurality of pivot points that connect to both said intermodal chassis, and said plurality of side walls;
said pivot points enable said plurality of sidewalls to open, providing space for a machine to both lower a series 1 freight container onto said intermodal chassis, and lift said series 1 freight container off of said intermodal chassis;
in this manner, an intermodal chassis and trailer are formed.

4) The intermodal chassis and trailer of claim 3 further comprising:
a means for both retracting, and extending said plurality of roof panels from said plurality of side panels,
in this manner, the intermodal chassis and trailer may open both, and close said plurality of roof panels, and said plurality of side panels to enable a series 1 freight container to be both lowered onto, and lifted out of said intermodal chassis and trailer.

5) In the field of intermodal logistics an intermodal chassis and trailer comprising:
an intermodal chassis having a floor;
a plurality of side walls;
a plurality of pivot points that connect to both said intermodal chassis, and said plurality of side walls;
said pivot points enable said plurality of side walls to open both, and close providing space for a machine to both lower a series 1 freight container onto said intermodal chassis, and lift said series 1 freight container off of said intermodal chassis;
a plurality of aerodynamic panels;
the plurality of side walls further having a structural frame with means for connection wherein said aerodynamic panels may be both attached to, and removed enabling the ability to upgrade aerodynamic performance with next generation aerodynamic panels;
in this manner, an intermodal chassis and trailer are formed.
